(19) United States
(12) Patent Application Publication
(10) Pub. No.: US 2026/0307230 A1
(43) Pub. Date: Oct. 8, 2026

(54) MACHINE TOOL ASSEMBLY AND LIGHTING SYSTEM FOR A MACHINE TOOL ASSEMBLY

(71) Applicant: Festool GmbH, Wendlingen (DE)

(72) Inventors: Daniel Schäuble, Badenweiler (DE); Christoph Dieter, Pfullingen (DE)

(73) Assignee: Festool GmbH, Wendlingen (DE)

(21) Appl. No.: 19/478,895

(22) PCT Filed: Apr. 26, 2024
(86) PCT No.: PCT/EP2024/061564

§ 371 Date: Oct. 27, 2025

(30) Foreign Application Priority Data
Apr. 28, 2023 (DE) 10 2023 203 959.1

(51) Int. Cl. B25F 5/00; B27C 5/10

(52) U.S. Cl. CPC B25F 5/00; B27C 5/10

(57) ABSTRACT

A machine tool assembly has a hand-operated machine tool and a lighting system. The hand-operated machine tool has an electric drive unit with a brushless DC motor and a motor control unit coupled by means of signals to the brushless DC motor. The lighting system has a lighting unit with at least one light source, a control unit, which is connected by means of signals to the lighting unit, wherein the control unit is designed to operate the lighting unit in pulsed light mode, and a signal interface, which is connected by means of signals to the control unit, wherein the signal interface is designed to receive a signal describing a movement state of the tool such that a lighting state can be adjusted to the movement state by means of the control unit in pulsed light mode. A lighting system can be used in the machine tool assembly.

The invention relates to a machine tool assembly and a lighting system for a machine tool assembly.

The machine tool assembly comprises a hand-operated machine tool and a lighting system.

If a hand-operated machine tool is used for machining a workpiece, it is important, inter alia, that a user of the hand-operated machine tool can clearly see a portion of the workpiece to be machined as well as an engagement portion of the tool interacting with the workpiece. A precise and high-quality work result can only be achieved in this way. In this context, lighting systems have become known which are used to illuminate the engagement portion of the workpiece to be machined and/or the engagement portion of the tool interacting with the workpiece. In this way, the engagement portion of the workpiece to be machined and/or the portion of the tool interacting with the workpiece are more visible.

The object of the present invention is to further improve such lighting systems and hand-operated machine tools equipped therewith, i.e. machine tool assemblies.

The object is achieved by a machine tool assembly which comprises a hand-operated machine tool and a lighting system. The hand-operated machine tool has an electric drive unit with a brushless DC motor and with a motor control unit coupled by means of signals to the brushless DC motor. The lighting system comprises a lighting unit with at least one light source, wherein the lighting unit is designed or can be designed in such a way that an engagement portion of a tool of the hand-operated machine tool can be illuminated by means of the light source in a state of use of the lighting system. Furthermore, the lighting system comprises a control unit, which is connected by means of signals to the lighting unit, wherein the control unit is designed to operate the lighting unit in pulsed light mode. Moreover, the lighting system comprises a signal interface, which is connected by means of signals to the control unit, wherein the signal interface is designed to receive a signal describing a movement state of the tool such that a lighting state can be adjusted to the movement state by means of the control unit in pulsed light mode. The lighting system can thus be used to make an engagement portion of the tool of the hand-operated machine tool clearly visible. This ensures a precise and high-quality work result.

The brushless DC motor is in particular without sensors. This means that the DC motor in particular does not have a sensor which is designed to detect a relative position of a rotor of the DC motor in relation to a stator of the DC motor. Furthermore in particular, this means that the DC motor does not have a sensor which is designed to detect a speed of the rotor relative to the stator. Such brushless DC motors without sensors therefore have a very simple design. They are therefore robust and reliable in operation.

The brushless DC motor used as the drive motor of the hand-operated machine tool is often referred to as a BLDC motor for short. BL motor or electrically commutated (EC) motor are common names for it too. Brushless DC motors have the advantage that they do not require brushes and can therefore be operated reliably and with low wear. The required commutation, as the term EC motor suggests, is carried out in electronic form by means of the motor control unit. Although the brushless DC motor is designed to be connected to a DC power source, it does not function, strictly speaking, as a conventional DC machine, but rather converts the supplied direct current into suitable three-phase current by means of the motor control unit, e.g. by means of pulse-width modulation, such that the brushless DC motor is operated, strictly speaking, as a three-phase machine. The motor control unit comprises an inverter for this purpose.

According to one embodiment, the signal interface is coupled by means of signals to the motor control unit for receiving the signal describing the movement state of the tool. In this way, the signal describing the movement state of the tool can be reliably received at the signal interface. The signal describes an operating frequency of the tool and/or a tool position of the tool. The operation of the lighting system can thus be reliably adjusted to the movement state of the tool.

The signal describing the movement state of the tool can be based on a drive signal for the brushless DC motor provided by the motor control unit. Alternatively or in addition, the signal describing the movement state of the tool can be based on a feedback signal transferred from the brushless DC motor, in particular from a stator of the brushless DC motor, to the motor control unit. The signal describing the movement state of the tool can thus be derived from a drive signal for the brushless DC motor provided by the motor control unit. Alternatively or in addition, the signal describing the movement state of the tool can be derived from a feedback signal transferred from the brushless DC motor to the motor control unit. In this way, the signal describing the movement state of the tool can be easily and reliably determined.

According to one variant, the drive signal can describe a motor current profile and/or a motor voltage profile Alternatively or in addition, the feedback signal can describe an induced voltage profile and/or an induced current profile. The motor voltage profile is, for example, described using a phase angle. The motor current profile and/or motor voltage profile are present in the motor control unit, as they are required for driving the brushless DC motor. Accordingly, no other sensors are required to generate the signal describing the movement state of the tool. In particular, no Hall sensors are required. The feedback signal is also a signal provided by essential components of the DC motor, i.e. those required to provide drive power, and is thus also present in the motor control unit. No dedicated sensor is thus required for providing the feedback signal either. In other words, the signal describing the movement state of the tool can be generated without sensors. This is particularly easy and efficient from a structural point of view. In addition, this is advantageous in terms of installation space. The machine tool assembly can thus have a compact design.

According to one embodiment, the brushless DC motor is driven by means of the motor control unit using so-called block commutation. As already mentioned, the brushless DC motor is, strictly speaking, operated as a three-phase machine. The brushless DC motor, more specifically the stator of the DC motor, can be driven by means of a number of stator coils, which are respectively formed by phase windings, i.e. electromagnets, which is higher than a number of magnetic poles of the rotor, which preferably comprises permanent magnets. In such a case, not all stator coils are required at any given time to drive the rotor. However, the rotation of the rotor with the permanent magnets induces a voltage in a stator coil, i.e. in a phase winding, which results in a current flow. This stator coil is in particular a stator coil that is not energised by the motor control unit at the given time. This induced voltage and/or the induced current depends on the rotational position of the rotor and can thus be used to generate the signal describing the movement state of the tool. No components other than the essential components of the DC motor, i.e. those required for providing drive power, are required for this.

According to another embodiment, the brushless DC motor is driven by means of the motor control unit using so-called field-oriented control (FOC). Field-oriented control is sometimes also referred to as vector control. Field-oriented control uses motor current profiles, i.e. drive currents for the brushless DC motor, as input values. Three motor current profiles are used for three-phase driving. A value representing a magnetic flux density and/or a value representing a torque can be calculated from the motor flow profiles. A so-called Clarke transformation can be used for this. These can be controlled by means of a PI controller to associated setpoint values and then converted back into voltage values by an inverse Clarke transformation, on the basis of which a commutation signal is provided. Furthermore, a rotor position can be calculated and a rotary speed of the rotor estimated on the basis of the value representing the magnetic flux density and/or the value representing the torque. A signal describing the movement state of the tool can thus also be generated in this way. The value representing the magnetic flux density is preferably used at a comparatively high rotational speed. The anisotropy of the rotor can also be exploited at a comparatively low rotational speed.

According to an additional embodiment, the brushless DC motor is driven by means of the motor control unit using a motor model. For this purpose, the motor model must be stored on the motor control unit, i.e. data that describes the behaviour of the brushless DC motor. During operation of the brushless DC motor, the motor model is executed, i.e. the behaviour of the brushless DC motor is simulated by means of the motor model in parallel with operation, so to speak. The motor control unit also comprises a controller, by means of which an error that occurs between an operating parameter of the actual brushless DC motor and a corresponding operating parameter of the motor model, is regulated to zero. In addition, the motor model can be used to generate a signal describing the movement state of the tool, e.g. a rotor position and a rotary speed of the rotor. Simply put, a rotor position and a rotary speed of the rotor can be determined using the motor model based on motor current profiles, i.e. drive currents for the brushless DC motor, and/or motor voltage profiles, i.e. drive voltages for the brushless DC motor.

According to one variant, the lighting unit, the control unit and the signal interface are arranged inside a housing of the hand-operated machine tool. In other words, the lighting system is integrated into the hand-operated machine tool. The machine tool assembly, i.e. in the present case, the hand-operated machine tool with integrated lighting system, can thus be easily handled. Furthermore, the components of the lighting system are protected inside the housing of the hand-operated machine tool from unwanted environmental influences.

In another variant, the lighting unit, the control unit and the signal interface are attached to a carrier unit. In addition, the lighting system is mechanically attached to an outside of the hand-operated machine tool via a mounting interface provided on the carrier unit. The lighting system is therefore attached externally to the hand-operated machine tool. This ensures that the lighting system can be easily retrofitted. It is understood that a mounting interface also has to be provided on the hand-operated machine tool in order to be able to attach the lighting system to the hand-operated machine tool. An adapter element can be used for this, which is fixedly connected to an exterior of the hand-operated machine tool and to the lighting system. Of course, it is alternatively also possible that such a mounting interface on the machine tool side is integrated into the hand-operated machine tool.

The hand-operated machine tool can comprise a machine spindle which can be rotated about an axis of rotation. At least one portion of the lighting system can run parallel to a circumference of the machine spindle at least in sections. For example, a portion of the lighting system completely surrounds the machine spindle. In such a configuration, an engagement portion of the tool of the hand-operated machine tool can be illuminated along at least two different directions by means of the lighting system. The engagement portion can be made particularly visible as a result.

That portion of the lighting system that runs parallel to the circumference of the machine spindle at least in sections is preferably spaced apart from the circumference of the machine spindle. In particular, the distance between the circumference of the machine spindle and the portion of the lighting system running parallel to the circumference of the machine spindle at least in sections can correspond to 1 to 5 times the diameter of the machine spindle. Further particularly, this distance can be 3 to 4 times the diameter of the machine spindle. In this way, the engagement portion of the tool of the hand-operated machine tool can be illuminated particularly well.

Furthermore, the lighting system can be arranged in a space which is spanned by a machine body of the hand-operated machine tool, a machine table of the hand-operated machine tool and linear guide elements of the hand-operated machine tool. The linear guide elements of the hand-operated machine tool are also referred to as columns if the hand-operated machine tool is a router. As a consequence, the external dimensions of the hand-operated machine tool are not increased by the lighting system. The lighting system thus only marginally influences handling of the hand-operated machine tool, if at all.

The machine tool can be a router. The router bit is thus clearly visible during operation thanks to the lighting system. This achieves a precise and high-quality work result.

The object is also achieved by a lighting system for a machine tool assembly according to the invention. The lighting system comprises:
the lighting unit with at least one light source, wherein the lighting unit can be designed in such a way that an engagement portion of a tool of the hand-operated machine tool can be illuminated by means of the light source in a state of use of the lighting system,
the control unit, which is connected by means of signals to the lighting unit, wherein the control unit is designed to operate the lighting unit in pulsed light mode,
the signal interface, which is connected by means of signals to the control unit, wherein the signal interface is designed to receive a signal describing a movement state of the tool such that a lighting state can be adjusted to the movement state by means of the control unit in pulsed light mode.

The control unit, which is designed to operate the lighting unit in pulsed light mode as well as the signal interfaces make it possible to adjust the operation of the lighting system to the operation of the hand-operated machine tool on which it is used. In this context, the signal received at the signal interface, which describes the movement state of the tool, can be received by a sensor unit, which is part of the lighting system. This will be explained in more detail below. Alternatively, it is possible that the signal received at the signal interface, which describes the movement state of the tool, is provided by the associated hand-operated machine tool. This of course presupposes that the associated hand-operated machine tool has a corresponding signal interface, by means of which such a signal can be tapped, for example, from the motor control of the hand-operated machine tool. In particular, in this context, the signal which describes the movement state of the tool can be provided by a motor control unit, which is designed to control a brushless DC motor. Both variants make it possible to render the moving tool, which is normally not sharply visible to the human eye because the movement of the tool is too fast and therefore cannot be resolved by the human eye, visible to the human eye, i.e. sharply visible. In this context, light pulses substantially synchronised with the movement of the tool are generated. In other words, the at least one light source is only switched on for a comparatively short period of time. In the case of a periodic movement of the tool, which can be rotational, translational or a combination thereof, a frequency of the light pulses can substantially correspond to the frequency of the periodic movement of the tool. Of course, it is also possible that the frequency of the light pulses relates to an integer multiple or an integer divisor of the frequency of the periodic movement of the tool. In the event that the tool has a plurality of cutting edges, the frequency of the light pulses can be selected such that it corresponds to a multiple of the frequency of the periodic movement of the tool corresponding to the number of cutting edges. The cutting edges of the tool are therefore always made visible by a light pulse in the same phase position of the periodic movement. In all variants of pulsed light mode, the outlines of the tool appear sharp to the human eye. This ensures a precise and high-quality work result.

In this context, it is also of importance that sharp perceptibility of the tool by the human eye is substantially achieved by virtue of the fact that the light pulse has a comparatively short pulse duration in pulsed light mode. However, comparatively few of these comparatively short light pulses can result in the tool appearing comparatively dark to the human eye. In order for the tool to appear lighter, comparatively many of these comparatively short light pulses therefore have to be produced. In other words, the perceived brightness of the tool can be adjusted by the number of light pulses. In all cases, the lighting frequency must be selected to be high enough that the individual light pulses cannot be resolved by means of the human eye.

In one variant, the signal interface and control unit are designed integrally. This means that the signal interface is designed as part of the control unit. This is particularly easy and also space-saving from a structural point of view.

Each of the light sources preferably comprises a light-emitting diode (LED). One or more of the light sources can be optionally equipped with an optical unit. The optical unit is designed to direct light generated by means of the light source onto the engagement portion of the tool of the hand-operated machine tool in a targeted manner. The optical unit comprises a lens and/or a diffuser, for example.

The lighting unit can comprise one or more light sources.

The lighting system according to the invention can be specifically designed for use on a hand-operated machine tool which is a router. In this case, the lighting system is a router lighting system. Alternatively, the lighting system according to the invention can be specifically designed for use on a hand-operated machine tool which is a saw. In this case, the lighting system is a saw lighting system. Furthermore, it is possible that the lighting system according to the invention is specifically designed for use on a hand-operated machine tool which is a sander. In this case, the lighting system is a sander lighting system. In this context, the sander can be designed as a random orbital sander. It is also possible that the lighting system according to the invention is specifically designed for use on a hand-operated machine tool which is a drill. In this case, the lighting system is a drill lighting system. According to another alternative, the lighting system according to the invention can be specifically designed for use on a hand-operated machine tool which is an oscillating multi-tool. In this case, the lighting system is a multi-tool lighting system. Oscillating multi-tools can also be simply referred to as oscillators.

The control unit can be designed to operate the lighting unit in continuous light mode. In this operating mode, the engagement portion of the tool is permanently illuminated. This is useful, for example, when the tool moves comparatively slowly or not at all. Continuous light mode ensures particularly good visibility of the engagement portion.

Alternatively or in addition, the signal interface can be designed to be coupled by means of signals to a motor control unit for receiving the signal describing the movement state of the tool, wherein the motor control unit is designed to control a brushless DC motor. In this way, the signal describing the movement state of the tool can be reliably received at the signal interface. The signal describes an operating frequency of the tool and/or a tool position of the tool. The operation of the lighting system can thus be reliably adjusted to the movement state of the tool.

In this context, the brushless DC motor is in particular without sensors. This means that the DC motor in particular does not have a sensor which is designed to detect a relative position of a rotor of the DC motor in relation to a stator of the DC motor. Furthermore in particular, this means that the DC motor does not have a sensor which is designed to detect a speed of the rotor relative to the stator. Such brushless DC motors without sensors therefore have a very simple design. They are therefore robust and reliable in operation.

As already mentioned, the signal describing the movement state of the tool can be based on a drive signal for the brushless DC motor provided by the motor control unit. Alternatively or in addition, the signal describing the movement state of the tool can be based on a feedback signal transferred from the brushless DC motor, in particular from the stator of the brushless DC motor, to the motor control unit. The signal describing the movement state of the tool can thus be derived from a drive signal for the brushless DC motor provided by the motor control unit. Alternatively or in addition, the signal describing the movement state of the tool can be derived from a feedback signal transferred from the brushless DC motor, in particular from the stator of the brushless DC motor, to the motor control unit. In this way, the signal describing the movement state of the tool can be easily and reliably determined.

According to one variant, the drive signal can describe a motor current profile and/or a motor voltage profile Alternatively or in addition, the feedback signal can describe an induced voltage profile and/or an induced current profile. The motor current profile and/or motor voltage profile are present in the motor control unit, as they are required for driving the brushless DC motor. The motor voltage profile is, for example, described using a phase angle. Accordingly, no other sensors are required to generate the signal describing the movement state of the tool. In particular, no Hall sensors or encoders are required. The feedback signal is also a signal provided by essential components of the DC motor, i.e. those required to provide drive power, and is thus also present in the motor control unit. No dedicated sensor is thus required for providing the feedback signal either. In other words, the signal describing the movement state of the tool can be generated without sensors. This is particularly easy and efficient from a structural point of view. In addition, this is advantageous in terms of installation space. The machine tool assembly can thus have a compact design.

In one exemplary embodiment, the lighting system comprises an energy interface for supplying the lighting unit and/or the control unit with electrical energy. The energy interface is used to feed energy into the lighting unit and/or control unit. The energy interface can be designed to be wired or wireless. According to a first variant, the energy supply is ensured via an energy-conducting connection, which can also be wired or wireless, to the hand-operated machine tool. In this case, the energy interface and mounting interface can be combined such that if the lighting system is mechanically connected to the hand-operated machine tool, the energy supply of the lighting system is ensured at the same time. Alternatively, the energy interface can be designed to be supplied with energy from a separate energy storage device. In both variants, the lighting unit and/or control unit can be reliably supplied with energy.

The lighting system can further comprise an electrical energy storage unit which is coupled to the energy interface. The electrical energy storage unit can be rechargeable or not. The electrical energy storage unit can be permanently installed in the lighting system or releasably connected to the remaining components of the lighting system. In the latter case, the electrical energy storage unit can be referred to as removable or replaceable. In the event that the electrical energy storage unit is permanently installed, it requires a charging interface in order to be recharged. The charging interface can be wireless or wired. Of course, a charging interface can also be provided if the electrical energy storage unit is removable or replaceable. This opens up the possibility of charging the electrical energy storage unit within the lighting system. In all of these cases, the lighting system is self-sufficient in terms of its energy supply, i.e. it does not require a supply of electrical energy from the hand-operated machine tool. This makes it easier to retrofit the lighting system.

According to one variant, an energy harvesting unit is connected to the energy interface. The energy harvesting unit is in particular designed to generate electrical energy from movements of the lighting system and/or the hand-operated machine tool connected to the lighting system. The energy harvesting unit can be used instead of an electrical energy storage unit or in combination with an electrical energy storage unit. In the first alternative, it is thus not necessary to replace or charge the electrical energy storage unit. In the second alternative, the electrical energy storage unit only has to be replaced or charged comparatively rarely. Both simplify the use of the lighting system.

The lighting system can further comprise a carrier unit. The carrier unit has a mounting interface for the optional mechanical attachment of the carrier unit to an outside of the hand-operated machine tool. The lighting unit and control unit are attached to the carrier unit. In this variant, the lighting system can thus be formed as a self-contained unit. In particular, the lighting system can be formed as a separate unit relative to the hand-operated machine tool to which it can be attached. It is also said in this context that the lighting system can be designed as a so-called add-on component. The lighting system is thus particularly suited to being retroffited to hand-operated machine tools. The age of the hand-operated machine tool is irrelevant, meaning that such a lighting system can be designed in a way that is both forward-compatible and backward-compatible. The lighting system can be mechanically attached to an outside of the hand-operated machine tool in a stable manner thanks to the mounting interface of the carrier unit. Such attachment can be direct, i.e. the carrier unit is directly connected to the outside of the hand-operated machine tool. Alternatively, an adapter element can be provided, which mechanically connects the outside of the hand-operated machine tool and the carrier unit. The lighting system according to the invention can be attached quickly and in a straight-forward manner. The same applies to removing the lighting system according to the invention from a hand-operated machine tool. As a result, the lighting system can be used quickly and in a straight-forward manner on various hand-operated machine tools.

In the present case, any side of the hand-operated machine tool is understood as an outside of the hand-operated machine tool if it is accessible from the outside, i.e. without dismantling one or more components of the hand-operated machine tool.

According to one embodiment, the mounting interface comprises at least one of a bayonet connection element, snap hook, connection magnet, mounting hole, fastening thread, mounting bolt and hook-and-loop fastening element. In all of these variants, the carrier unit can be attached to the outside of the hand-operated machine tool in a mechanically stable manner.

In one exemplary embodiment, the carrier unit has at least one annular or ring segment-shaped portion. The annular or ring segment-shaped portion extends at least partially around a central axis. In the state of use of the lighting system, this axis can coincide with a tool axis, i.e. an axis of rotation, oscillation axis or stroke axis of the tool, or an axis of a drive element for the tool. In other words, the tool or an associated drive element is accommodated inside the annular or ring segment-shaped portion. As a result, the tool or drive element can be illuminated from a plurality of sides. In this way, shadows and other unwanted effects of lighting are avoided. In the event that the carrier unit comprises a ring segment-shaped portion, a recess that complements the ring segment-shaped portion to form a complete ring can be used to transfer the tool or drive element inside the ring segment-shaped portion when assembling the lighting system. Such a carrier unit can therefore be mounted on an associated hand-operated machine tool in a particularly simple manner.

The lighting unit can comprise a plurality of light sources. The light sources can be arranged along an arc line. The arc line can, for example, be a circular arc line or an elliptical arc line. This results in particularly uniform illumination. In addition, shadows and other unwanted lighting effects are avoided.

According to one example, the signal interface is designed to receive, as the signal describing the movement state of the tool, at least one of a signal describing an operating frequency of the tool and a signal describing a tool position of the tool. An operating frequency is always suitable for describing the movement state of the tool if the tool performs a periodic movement. In the event that the tool rotates, the rotation frequency is the operating frequency. In the event that the tool oscillates, the oscillation frequency is the operating frequency. In the event that the tool moves periodically in a translational manner, the stroke frequency is the operating frequency. The tool position can be a translational position or a rotary position of the tool. In the event that the tool performs a periodic movement, the tool position is also understood as a phase position. As a result, the engagement portion of the tool can be illuminated as a function of the operating frequency of the tool and/or the tool position. In one example where the tool moves periodically and a lighting frequency in pulsed light mode substantially corresponds to the associated operating frequency or is an integer multiple thereof, the effect of an optically stationary tool is produced. As already mentioned, the tool appears sharp to the human eye. This enables a precise and high-quality machining result. In another example, the lighting sequence corresponds to the operating frequency multiplied by a number of cutting edges of the tool. This results in the same effects.

The lighting system can comprise a sensor unit, wherein the sensor unit is designed to detect the operating frequency and/or the tool position and to produce the signal describing the operating frequency and/or tool position and is coupled by means of signals to the signal interface. The signals describing the operating frequency and/or the tool position can thus be produced by means of the lighting system. It is therefore not necessary to rely on the hand-operated machine tool for this purpose. This enhances the compatibility of the lighting system with various hand-operated machine tools. Furthermore, installation work is reduced as substantially only a mechanical coupling between the lighting system and hand-operated machine tool is required.

According to one embodiment, the sensor unit comprises a sensor element on the carrier unit side, which is attached to the carrier unit. Since the carrier element is usually stationary, the operating frequency and/or the tool position can be reliably detected by means of such a sensor element.

In one example, the sensor element on the carrier unit side comprises a Hall sensor or an induction coil. In this way, an operating frequency and/or a tool position of a magnetically encoded tool can be easily and reliably detected by means of sensors. The tool itself, such as a milling cutter, drill bit or saw blade, can be magnetically encoded or connected to a magnetically encoded element. Alternatively or in addition, a tool holder is magnetically encoded.

In another example, the sensor element on the carrier unit side comprises a proximity sensor, which functions inductively, for example. In this way, an operating frequency and/or a tool position of a tool coded by means of recesses and/or elevations can be easily and reliably detected by means of sensors. The tool itself, such as a milling cutter, drill bit or saw blade, can be coded by means of recesses and/or elevations or connection to a coded element on which recesses and/or elevations are formed. Alternatively or in addition, a tool holder is coded by means of recesses and/or elevations.

In another example, the sensor element on the carrier unit side comprises an optical sensor. In this way, an operating frequency and/or a tool position of an optically encoded tool can be easily and reliably detected by means of sensors. The tool itself, such as a milling cutter, drill bit or saw blade, can be optically encoded or connected to an optically encoded element. Alternatively or in addition, a tool holder is optically encoded. The optical encoding relates, for example, to areas with different surface reflectivity or areas otherwise coded with different optical properties. In this context, the optical encoding can be specifically and exclusively provided for interaction with the optical sensor of the sensor element on the carrier unit side. Alternatively, existing structural elements on the tool or the tool holder, which have a different surface reflectivity or otherwise different optical properties compared to other structural elements, can be used as optical encoding. In this context, a spindle stop bore can be used, for example, as optical encoding.

The sensor unit can also comprise a sensor element on the tool side, which can be coupled to the tool or to a drive element coupled to the tool or which can be integrated into the tool or the drive element. The sensor element on the tool side interacts with the sensor element on the carrier unit side. As already mentioned, the sensor element on the tool side can be a magnetic sensor element. Alternatively, the sensor element on the tool side can have elevations and/or recesses. Further alternatively, the sensor element on the tool side can comprise optical encoding. In all variants, an operating frequency and/or a tool position can be reliably and precisely detected.

The sensor element on the tool side can be annular and have a mounting interface on an inner ring circumference for coupling to the tool or the drive element. The sensor element on the tool side can thus be easily and reliably coupled to the tool or an associated drive element. The lighting system is thus compatible with a plurality of different hand-operated machine tools.

According to one embodiment, at least one of a lighting frequency and lighting phase position can be adjusted to the movement state of the tool as the lighting state by means of the control unit in pulsed light mode. As already mentioned, a coordinated lighting frequency can be used to create the impression of a stationary tool, wherein the tool is in sharp focus. A coordinated lighting phase position can also be used to variably adjust a position of the tool in which the tool appears stationary. Overall, the state in which the tool is in sharp focus can therefore be selected comparatively freely and changed comparatively flexibly. As a result, the display can be adapted to a specific hand-operated machine tool and/or to a specific machining task.

The lighting system can have an adjustment means for manually modifying at least one of the lighting frequency and lighting phase in pulsed light mode, wherein the adjustment means is connected by means of signals to the control unit. A lighting characteristic can thus be variably adjusted by a user. As a result, a user can always select that lighting characteristic that they deem appropriate in connection with the hand-operated machine tool coupled to the lighting system and the machining task to be carried out. This further increases the visibility of the engagement portion of the tool.

In this context, a lighting phase can be understood, for example, relative to a tool position, in particular to a phase position of the tool. The lighting phase can be modified by increasing or reducing a time offset between receiving a sensor signal which describes the tool position and switching on a light pulse. This applies if the tool moves at an at least temporarily constant operating frequency, such as rotation frequency, oscillation frequency or stroke frequency. In the event that the operating frequency of the tool fluctuates, for example due to a load acting on the tool, the time offset between receiving the sensor signal and switching on the light pulse must be further adapted to the current operating frequency so that illumination can be achieved that is independent of the operating frequency, i.e. that remains constant even when the operating frequency changes. In this context, the user can set a desired tool position by means of the adjustment means, such as a rotational position, oscillation position or stroke position, in which the tool is to appear when illuminated in pulsed light mode. The required time offset between the sensor signal and light pulse can thus be continuously calculated, for example by means of the control unit, from this predetermined tool position and a current operating frequency, which is determined based on detection results from the sensor unit described above. As a result, the tool can be illuminated in such a way that it is sharp and appears stationary to the human eye even with a fluctuating operating frequency.

In one example, the adjustment means is designed as a rocker switch. The rocker switch can comprise two switching elements, wherein one of the switching elements is used to increase at least one of the lighting frequency and lighting phase and the respective other switching element is used to reduce the respective other of the lighting frequency and lighting phase. Alternatively, it is of course also possible to use one or more switches. In another alternative, the adjustment means comprises capacitive tactile sensors or ultrasonic tactile sensors.

The lighting system can comprise one or more other control elements, wherein the one or more other control elements is/are connected by means of signals to the control unit.

For example, another control element is designed to be able to manually modify a brightness of the illumination. If the light sources are driven by a pulse-width modulated signal, the brightness can be adjusted by manipulating the pulse width.

Alternatively or in addition, one of the other control elements is designed to be able to manually switch between different operating modes of the lighting system. In this context, it is possible to switch between continuous light mode and pulsed light mode, for example.

Another control element can be designed to switch the lighting system on and/or off.

The same types of switches are suitable for the one or more other control elements as those explained in connection with the adjustment means.

Furthermore, it is understood that individual control elements can be assigned a plurality of functions by distinguishing, for example, between different actuation times and/or evaluating multiple actuations (e.g. “double click”).

According to one embodiment, all control elements are arranged in such a way that they can be operated while the hand-operated machine tool to which the lighting system is coupled is in operation. A mechanical protective element is optionally provided, which is positioned between the respective control element and a working area of the hand-operated machine tool such that a human finger or a human hand used to operate the adjustment means cannot accidentally get into the region of the tool, i.e. into a danger zone. This increases the operational safety of the hand-operated machine tool.

The lighting system can comprise a display unit for displaying at least one of an operating state of the lighting system, warning message, error message and user feedback. If an electrical energy storage unit is present, a charging state of the electrical energy storage device can also be displayed. In this way, a user of the lighting system is always informed of the operating state of the lighting system as such and/or of components of the lighting system.

In one variant, the display unit comprises at least one display means separate from the lighting unit, which is in particular attached to the carrier unit. Alternatively, the display unit can be provided on an outside of the hand-operated machine tool. A display can thus be shown regardless of whether the lighting unit is switched on or off. The display means comprises, for example, a light-emitting diode (LED), a light guide, a display, a light guide arc or a light guide ring, which can be designed as a fibre-optic tube. The display means is preferably designed as a light guide arc, which is arranged on an outer circumference of the carrier element. Combinations of these examples are of course also possible. The display means can also be designed to generate displays in different colours. In this context, for example, displays related to potentially dangerous operating states can be shown in red. Other displays are shown in green.

In one example, the display means of the lighting unit is designed as a light guide ring, which is closed around its circumference. The light guide ring is attached to the carrier unit or provided on an outside of the hand-operated machine tool in such a way that it is clearly visible to a user of the lighting system and in particular to a user of a hand-operated machine tool to which the lighting system is attached during operation of the lighting system and/or the hand-operated machine tool. If available, the carrier unit can be mounted on the hand-operated machine tool in such a way that a tool or a machine spindle extends through the inside of the light guide ring, i.e. a region surrounded by the light guide ring. A user of the hand-operated machine tool to which the lighting system is attached, who is looking at the tool or the machine spindle, can thus also see the light guide ring and the light emanating from it, regardless of the direction from which they are looking. The same applies if the lighting system is integrated into the hand-operated machine tool. A display means designed as a light guide ring is thus very clearly visible.

In another example, the display means of the lighting unit is designed as a light guide arc. The light guide arc is attached to the carrier unit or provided on an outside of the hand-operated machine tool in such a way that it is clearly visible to a user of the lighting system and in particular to a user of an associated hand-operated machine tool during operation of the lighting system and/or the hand-operated machine tool. The carrier unit can be mounted or provided on the hand-operated machine tool in such a way that the light guide arc runs partially around a tool or around a machine spindle. The light guide arc is arranged such that it and/or light emanating from the light guide arc lies in the field of vision of a user when the user looks at the tool or at the machine spindle from the most common directions. A display means designed as a light guide arc is thus clearly visible.

According to one alternative, at least one light source of the lighting unit is a display means of the display unit. This means that at least one light source is used both for illuminating the engagement portion of the tool and as a display means. In other words, this light source has two functions. The lighting system can have a comparatively compact design as a result.

In one variant, the lighting system comprises a safety sensor unit, which is attached to the carrier unit. The safety sensor unit is designed to detect a human finger or human hand in the region of the carrier unit. Furthermore, the safety sensor unit is coupled by means of signals to the control unit such that an operating state of the lighting unit can be adjusted as a function of a detection result of the safety sensor unit. The safety sensor unit comprises, for example, a capacitive sensor or a group of capacitive sensors. A human finger and/or a human hand located in the vicinity of the tool, i.e. in the vicinity of a danger zone, can thus be detected by means of the safety sensor unit. As the safety sensor unit is coupled to the control unit, and also the lighting unit is coupled to the control unit, the lighting system can thus be operated as a function of a detection result of the safety sensor unit. For example, illumination can be switched from pulsed light mode to continuous light mode on the basis of a detection result of the safety sensor unit. Alternatively or in addition, it is possible that a warning is output by means of the lighting system.

It is understood that all features, effects and advantages mentioned in connection with the lighting system also apply to the machine tool assembly and vice versa.

The invention is explained below based on various exemplary embodiments, which are shown in the appended drawings. In the drawings:

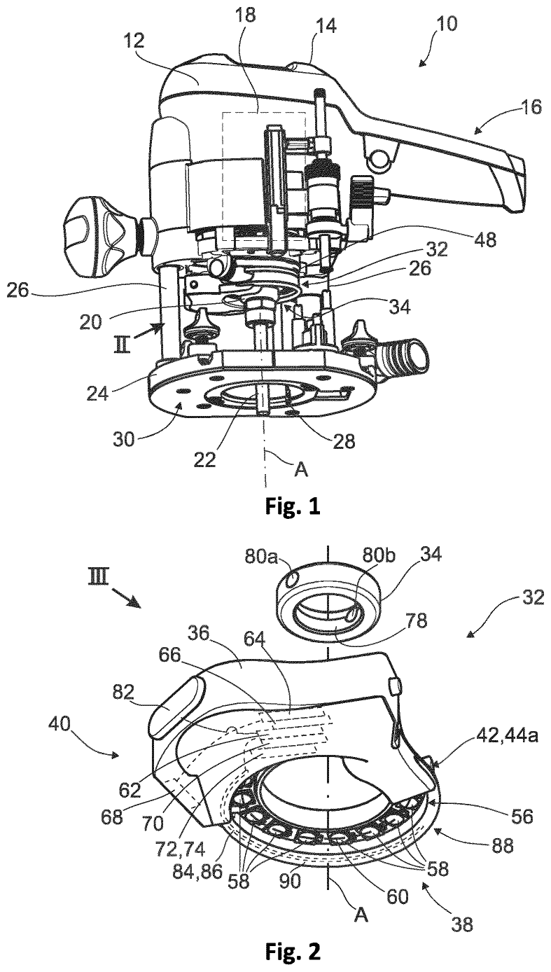

FIG. 1 shows a machine tool assembly according to the invention comprising a hand-operated machine tool, which is designed as a router, and a lighting system according to the invention,

FIG. 2 shows the lighting system shown in FIG. 1 in a separate view along the direction II in FIG. 1,

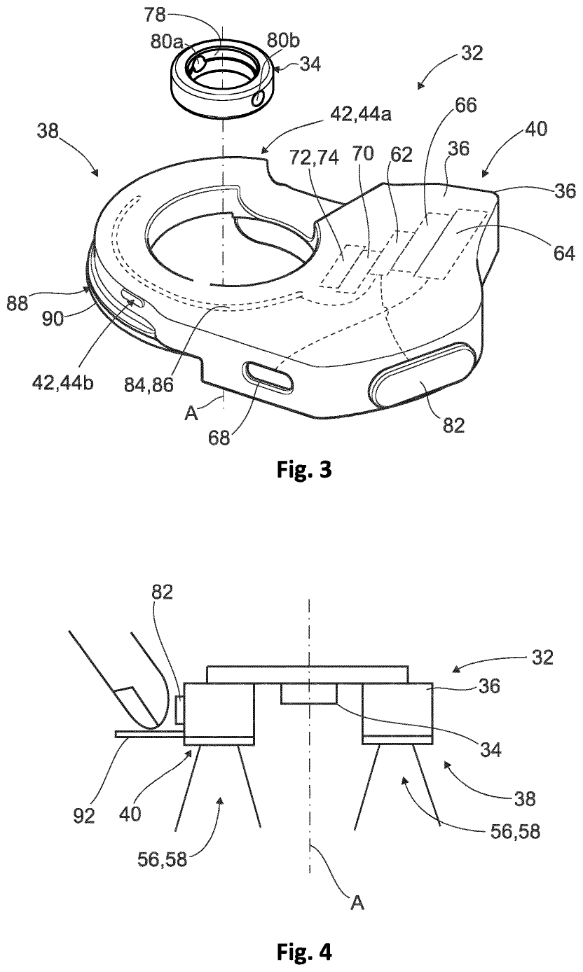

FIG. 3 shows the lighting system shown in FIG. 2 in a view along the direction III in FIG. 2,

FIG. 4 shows a variant of the lighting system shown in FIGS. 1 to 3,

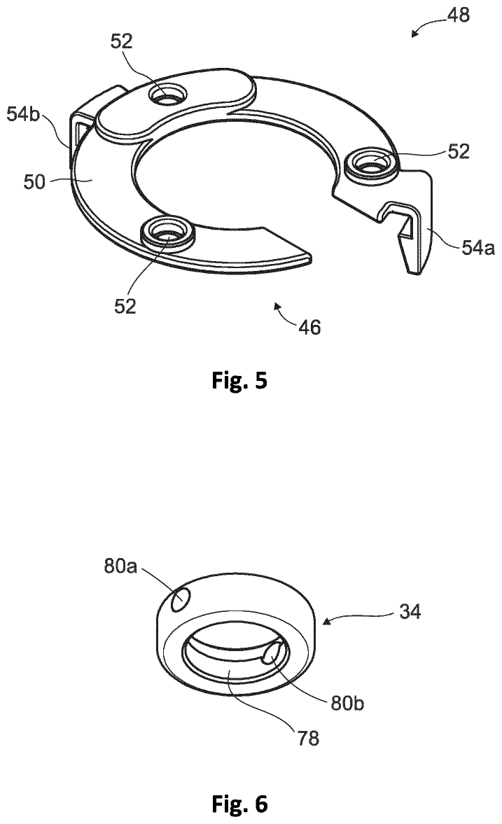

FIG. 5 shows an adapter element for mechanically connecting an outside of the hand-operated machine tool and the lighting system shown in FIGS. 1 to 3,

FIG. 6 shows a sensor element, on the tool side, of the lighting system shown in FIGS. 1 to 4,

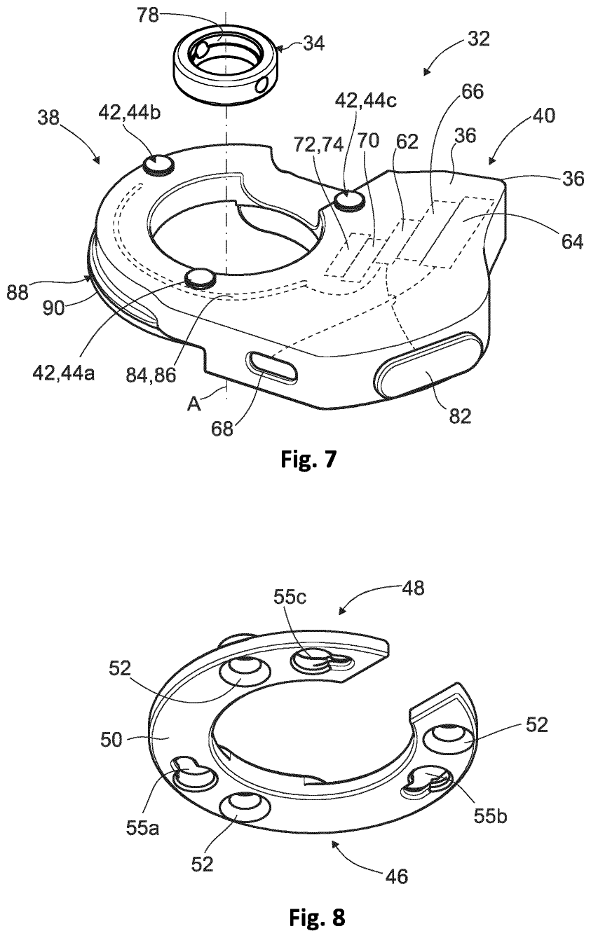

FIG. 7 shows a lighting system according to the invention in accordance with another embodiment in a view, which corresponds to the view shown in FIG. 3,

FIG. 8 shows an adapter element according to another embodiment for mechanically connecting an outside of the hand-operated machine tool and the lighting system shown in FIG. 7, and

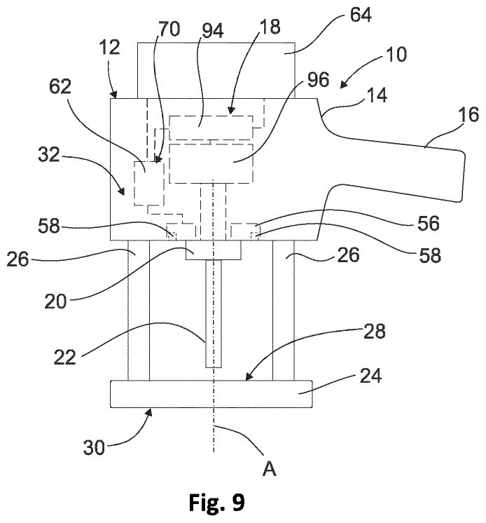

FIG. 9 shows a machine tool assembly according to the invention in accordance with another embodiment, comprising a hand-operated machine tool, which is designed as a router, and a lighting system according to the invention.

FIG. 1 shows a machine tool assembly 10, which comprises a hand-operated machine tool 12, which is formed as a router in the examples shown.

The hand-operated machine tool 12 comprises a machine body 14, on which a grip portion 16 is formed.

Furthermore, a drive unit 18 is arranged in the machine body 14.

The drive unit 18 comprises an electric motor by means of which a machine spindle 20 can be driven in rotation. The machine spindle 20 can be rotated about an axis of rotation A.

In the present case, the drive unit 18 comprises an electric motor designed as a brushless and sensorless DC motor as well as a motor control unit coupled by means of signals to the brushless DC motor in order to control it.

In the example shown, a tool 22 is coupled to the machine spindle 20 in terms of drive.

Since the hand-operated machine tool 12 is a router, the tool 22 is a milling cutter. hand-operated machine tool 12 further comprises a machine table 24, which is spaced apart from the machine body 14 and can be displaced translationally relative to the machine body 14 via linear guide elements 26.

An opening 28 is provided in the machine table 24, whose central axis is arranged concentrically to the axis of rotation A. The axis of rotation A can thus also be considered a central axis of the opening 28.

The machine table 24 comprises a sliding surface 30, which is designed to be placed against a workpiece to be machined (not shown in detail in the figures) or a guide device during operation of the hand-operated machine tool 12.

The machine table 24 and the opening 28 are arranged such that the tool 22 can pass through the opening 28 during operation of the hand-operated machine tool 12 in order to machine the workpiece.

The machine tool assembly 10 further comprises a lighting system 32. This is shown in FIGS. 2 and 3 separately from the hand-operated machine tool 12. Compared to the installation situation shown in FIG. 1, a sensor element 34, on the tool side, of the lighting system 32 is shown offset relative to the remaining components of the lighting system 32 for the purpose of better visibility.

The lighting system 32 comprises a carrier unit 36.

In the embodiment shown, the carrier unit 36 is designed as a housing. This means that the carrier unit encloses a space in which other components of the lighting system 32 are arranged, as will be explained below.

The carrier unit 36 comprises an annular portion 38 and a rectangular portion 40 integrally connected thereto.

The annular portion 38 and the rectangular portion 40 merge into one another.

In the present case, the annular portion 38 is circular.

The carrier unit 36 is designed as a plastic assembly in the examples shown. This means that the carrier unit 36 is composed of a plurality of plastic components.

The carrier unit 36 is, on the one hand, designed to optionally mechanically attach the lighting system 32 to an outside of the hand-operated machine tool 12.

For this purpose, the carrier unit 36 comprises a mounting interface 42.

In the embodiment shown, the mounting interface 42 comprises two bead-shaped mounting projections 44a, 44b. These are both positioned on an outer circumference of the annular portion 38 of the carrier unit 36.

The mounting interface 42 of the lighting system 32 is designed to interact with a mounting interface 46 on the machine tool side.

The mounting interface 46 on the machine tool side is formed on an adapter element 48, which is shown in detail in FIG. 5.

The adapter element 48 comprises a ring segment-shaped base body 50, which is provided with openings 52.

The adapter element 48 can thus be attached to the machine body 14 by means of screws (not shown in detail), which are inserted through the openings 52.

Moreover, the adapter element 48 has two snap hooks 54a, 54b.

The snap hooks 54a, 54b are designed to engage behind a respectively associated mounting projection 44a, 44b.

The adapter element 48 is attached to the machine body 14 in such a way that the axis of rotation A coincides with a central axis of the ring segment-shaped base body 50 (see FIG. 1).

Accordingly, the carrier unit 36 can be attached to the hand-operated machine tool 12 in such a way that the axis of rotation A coincides with a central axis of the annular portion 38 of the carrier unit 36.

In the assembled state of the lighting system 32, the machine spindle 20 and/or the tool 22 thus extend(s) through a central opening of the annular portion 38 of the carrier unit 36.

It is understood that the mounting interface 42 of the lighting system 32 described and the mounting interface 46 on the machine tool side described merely constitute examples. In particular, a kinematic reversal of the embodiment described is alternatively conceivable in which the snap hooks are arranged on the carrier unit 36 of the lighting system 32, and mounting projections are provided on the adapter element 48.

Moreover, it is conceivable to design the mounting interface 46 on the machine tool side as a mounting interface integrated into a housing of the hand-operated machine tool. In this case, no adapter element 48 separate from the hand-operated machine tool 12 is required.

The carrier unit 36 is, on the other hand, designed to carry other components of the lighting system 32.

In this context, the lighting system 32 comprises a lighting unit 56.

The lighting unit 56 comprises a plurality of light sources 58, wherein each of the light sources 58 comprises an LED in the embodiment shown.

The light sources 58 are attached to the annular portion 38 of the carrier unit 36. It can thus also be said that the lighting unit 56 is attached to the carrier unit 36. The light sources 58 are arranged along an arc line 60, which extends concentrically to the annular portion 38 of the carrier unit 36.

Since the annular portion 38 is circular, the arc line 60 is a closed circular arc line in the present case. The light sources 58 are distributed uniformly over the circumference of the circular arc line The light sources 58, or more generally the lighting unit 56, are designed in such a way that the light sources 58 or overall the lighting unit 56 can illuminate an engagement portion of the tool 22 in a state of use of the lighting system 32 (see FIG. 1). In this context, an engagement portion is understood as that section of the tool 22, which is intended to interact with a workpiece to be machined.

In a situation in which the hand-operated machine tool 12 is actually used to machine a workpiece, a portion of the workpiece which is currently interacting with the tool 22 is thus of course also illuminated.

The lighting system 32 further comprises a control unit 62.

The control unit 62 is also mechanically attached to the carrier unit 36.

Furthermore, the control unit 62 is connected by means of signals to the lighting unit 56. In this context, the control unit 62 is connected directly or indirectly by means of signals to each of the light sources 58.

Moreover, the lighting system 32 comprises an electrical energy storage unit 64, which is coupled to an energy interface 66.

The energy interface 66 is connected electrically, i.e. in an energy-conducting manner, both to the lighting unit 56 and to the control unit 62. In other words, the control unit 62 and lighting unit 56 are supplied with electrical energy from the electrical energy storage unit 64 via the energy interface 66.

In the embodiment shown, the electrical energy storage unit 64 is designed as a rechargeable battery. Accordingly, the electrical energy storage unit comprises a charging socket 68, via which the electrical energy storage unit 64 can be charged by means of a charging cable.

It is understood that the electrical energy storage unit 64 can also be designed in one alternative to be charged in a contactless manner, for example via an inductive charging interface.

Moreover, it is understood that, alternatively or in addition to the electrical energy storage unit 64, the lighting system 32 can comprise an energy harvesting unit, which is connected to the energy interface 66.

Furthermore, the control unit 62 comprises a signal interface 70.

In addition, the lighting system 32 comprises a sensor unit 72, which is coupled to the signal interface 70, i.e. connected by means of signals to the signal interface 70.

In the embodiment shown, the sensor unit 72 comprises a sensor element 74 on the carrier unit side. The sensor element 74 on the carrier unit side is attached to the carrier unit 36. In the embodiment shown, the sensor element 74 on the carrier unit side comprises a magnetic sensor, such as a Hall element. The sensor element 74 on the carrier unit side is arranged on the carrier unit 36 such that it can detect a magnetic flux in an inner region of the annular portion 38 of the carrier unit 36.

Moreover, the sensor unit 72 comprises the sensor element 34 on the tool side.

The sensor element 34 on the tool side is annular in the embodiment shown. (see also FIG. 6). It has a mounting interface 78 on an inner ring circumference, by means of which the sensor element 34 on the tool side can be coupled to the tool 22 or to the machine spindle 20.

In the embodiment shown, the sensor element 34 on the tool side is clamped onto the machine spindle 20.

Generally speaking, the machine spindle 20 constitutes a drive element coupled to the tool 22.

Two permanent magnetic elements 80a, 80b are also integrated diametrically opposite each other into the annular sensor element 34 on the tool side.

During operation of the hand-operated machine tool 12 and lighting system 32, the two permanent magnetic elements 80 a, 80 b can thus be detected by means of the sensor element 74 on the carrier unit side.

A rotary tool position of the tool 22, i.e. a rotational position of the tool 22, can thus be detected.

Moreover, an operating frequency of the tool 22 can be detected in this way. Since the tool 22 is a rotating tool, the operating frequency is a rotation frequency in the present case.

In other words, the sensor unit 72 is designed to detect the operating frequency and tool position and to produce a signal describing the operating frequency and a signal describing the tool position.

The signal describing the operating frequency and the signal describing the tool position are provided at the signal interface 70.

The signal interface 70 is consequently designed to receive a signal describing a movement state of the tool 22. More specifically, the signal interface 70 is designed to receive a signal describing the operating frequency of the tool 22 and a signal describing the tool position of the tool 22.

On this basis, the lighting unit 56 can be driven in pulsed light mode using the control unit 62. This means that the light sources 58 are switched on in a targeted manner for a comparatively short time and then switched off again. In other words, the control unit 62 is designed to operate the lighting unit 56 in pulsed light mode.

The lighting state can be adjusted to the movement state of the tool 22, i.e. to the operating frequency of the tool 22 and the tool position of the tool 22.

In the event that the tool 22 rotates so fast that this rotational movement can no longer be resolved by means of the human eye, the tool 22 appears to a human in the form of a blurry outer silhouette.

In such a situation, the tool 22 can be illuminated by means of the pulsed light mode in such a way that it appears sharp and stationary to the human eye.

The tool 22 not sharply perceptible by means of the human eye can thus be made sharply perceptible by means of the pulsed light mode.

For this purpose, the tool 22 is illuminated, for example, at a frequency, which corresponds to the operating frequency of the tool 22, an integer multiple of the operating frequency or an integer divisor of the operating frequency of the tool 22. In this context, the frequency of the illumination is understood as how often the light sources 58 are switched on and back off within a predetermined period of time. The frequency of the illumination can also be referred to as the lighting frequency.

In one example where the tool 22 rotates 6000 times per minute, i.e. the operating frequency is 100 Hz, the tool 22 can be illuminated by means of the light sources 58 at a frequency of 200 Hz, for example. The tool 22 is therefore illuminated in flashes 200 times per second. As a result, the tool 22 appears stationary to a user in the same position. The durations of the flash-like illumination, i.e. the pulse duration of a light pulse, are selected to be comparatively short. The comparatively short pulse duration results in the tool 22 appearing in sharp focus to the human eye. The fact that considerably more light pulses are generated at a lighting frequency of 200 Hz than can be resolved by the human eye means that the tool 22 appears bright to the human eye.

The lighting frequency in pulsed light mode is fixed by the control unit 62 in the example shown.

The lighting system 32 further comprises an adjustment means 82, which is designed as a rocker switch in the embodiment shown.

The adjustment means 82 is designed to adjust a phase shift between the operating frequency of the tool 22 and the lighting frequency. In other words, a lighting phase position can be adjusted.

The adjustment means 82 is connected by means of signals to the control unit 62 for this purpose.

By adjusting the phase shift, i.e. the lighting phase position, a user can select that rotational position of the tool 22 in which the tool 22 appears stationary contrary to reality.

The control unit 62 can therefore also be used in this respect to adjust the lighting state to the movement state of the tool 22 in pulsed light mode.

The lighting system 32 further comprises a safety sensor unit 84.

The safety sensor unit 84 is also attached to the carrier unit 36.

Furthermore, the safety sensor unit 84 is coupled by means of signals to the control unit 62.

In the present case, the safety sensor unit 84 is designed as a capacitive sensor unit and comprises an electrode 86, which extends along the annular portion 38 of the carrier unit 36.

In this way, a human finger or human hand can be detected in the region of the carrier unit 36, more specifically in the region of the carrier unit 36 equipped with the electrode 86.

Generally speaking, an operating state of the lighting unit 56 can be adjusted in this way as a function of a detection result of the safety sensor unit 84.

In addition, the lighting system 32 comprises a display unit 88, which is attached to the carrier unit 36.

The display unit 88 is coupled by means of signals to the control unit 62.

The display unit 88 is used to display at least one of an operating state of the lighting system 32, a warning message, an error message and user feedback.

In the present case, the display unit 88 comprises a display means 90 separate from the lighting unit 56.

In the embodiment shown, the display means 90 is designed as a light guide arc, which can optionally provide red, green and blue illumination. Moreover, the light guide arc is designed to optionally operate in continuous light mode and in flashing light mode. The light guide arc extends along a circumference of the annular portion 38 of the carrier unit 36.

More specifically, the light guide arc extends over a portion of 180 degrees of the circumference of the annular portion 38. The light guide arc is positioned such that it extends from a left-hand side of the hand-operated machine tool 12 to a right-hand side of the hand-operated machine tool 12 in relation to an operating direction of the hand-operated machine tool 12, which runs substantially parallel to the longitudinal extension of the grip portion 16. The operating direction of the hand-operated machine tool 12 thus intersects the light guide arc in the middle. In other words, the light guide arc is positioned symmetrically in relation to the operating direction. As a result, the light guide arc is clearly visible both from the left-hand side of the hand-operated machine tool 12 and from the right-hand side of the hand-operated machine tool.

It is understood that the extension of the light guide arc over 180 degrees should be understood as an example. The light guide arc can also extend over any other angle between 90 degrees and 270 degrees, such as over 120 degrees or over 240 degrees. The light guide arc is clearly visible in these examples too.

According to another example, instead of a single light guide arc, a plurality of smaller light guide arcs are provided, which are distributed along the circumference of the annular portion 38 in such a way that a user can always clearly see at least one light guide arc regardless of their line of sight. For example, at least two light guide arcs can be provided, which are arranged at opposite sides of the annular portion.

In the exemplary embodiment shown, the light guide arc lights up red continuously when the control unit 62 issues an error message.

Moreover, the light guide arc flashes red when the lighting system 32 is operated in pulsed light mode. In this way, a user is warned not to reach into the tool 22, which only appears stationary in pulsed light mode. The flashing red light guide arc thus simultaneously displays an operating state and a warning.

In the event that the lighting system 32 is operated in continuous light mode, i.e. the light sources 58 provide continuous illumination, the light guide arc can provide continuous green illumination. In this way, a user understands that no particular hazards result from the operation of the lighting system 32.

When switching between continuous light mode and pulsed light mode, the light guide arc can flash alternately red and green for a specified number of repetitions. This constitutes feedback for a user such that the user knows that they have switched operating state accordingly.

Furthermore, in the exemplary embodiment shown, the light guide arc flashes blue when the control unit 62 is currently establishing a data connection via an optional, wireless data interface, which will be described below in more detail. Once the data connection has been established, the light guide arc can emit a permanent blue light. This also constitutes feedback for a user.

It is understood that the properties of the light guide arc are not limited to the colours red, green and blue.

Moreover, it is conceivable to also display a warning by means of the display unit 88, i.e. the light guide arc, that the electrical energy storage unit 64 has a low state of charge.

Generally speaking, the display unit 88 can encode information for a user by a colour, by a type of illumination and by the fact of whether the display unit 88 is illuminated or not.

In order to further protect against a situation where a user operating the lighting system 32 in pulsed light mode accidentally reaches into the tool 22 because it appears stationary, the control unit 62 can be optionally designed to periodically interrupt the pulsed light mode with continuous light mode. In this way, the illusion of the stationary tool 22 is interrupted such that the hazards associated with the rotating tool 22 are more clearly visible to a user.

According to another option, the control unit 62 is designed to periodically change the phase shift between the operating frequency and the lighting frequency in pulsed light mode between two predetermined phase shift values. To a user, the tool 22 thus alternately appears in a rotational position associated with a first phase shift value and in another rotational position associated with a second phase shift value. Here too, the illusion of the stationary tool 22 is periodically interrupted such that the hazards associated with the rotating tool 22 are more clearly visible to a user.

Furthermore, the control unit 62 can be designed to interrupt pulsed light mode if a minimum speed, i.e. a minimum operating frequency of the tool 22 is undershot or the hand-operated machine tool is detected to be inactive.

According to another option, the lighting system 32 comprises a wireless data interface, such as a Bluetooth interface, wifi interface, ANT+ interface, GSM interface or infrared interface. This data interface is coupled to the control unit 62. Moreover, this interface can be used to configure the lighting system 32. Any data processor can be used for this, such as a mobile telephone, a tablet or a laptop.

For example, basic settings for the lighting system 32 can be configured or modified via such a data interface. The device coupled to the lighting system 32 via the data interface, i.e. the mobile telephone, tablet or laptop, preferably has a user interface designed for this purpose. In this context, for example, a basic brightness of the lighting, a number of cutting edges on the tool 22, or the assignment of buttons on the lighting system 32, e.g. for left-or right-handed users, can be set. In this context, the adjustment means 82 comprises buttons.

FIG. 4 shows a variant of the lighting system 32. Only the differences with the aforementioned embodiment will be mentioned below.

The lighting system 32 according to FIG. 4, more specifically the carrier unit 36 according to FIG. 4, comprises a plate-shaped safety projection 92 in the region of the adjustment means 82 on a side of the adjustment means 82 facing the tool 22. The safety projection 92 protrudes outwards and prevents a user operating the adjustment means 82 from accidentally reaching into the region of the tool 22 with their finger or hand.

FIG. 7 shows a lighting system 32 according to an alternative embodiment. Once again, only the differences with the aforementioned embodiments will be discussed.

The differences here relate to the mounting interface 42 of the carrier unit 36 and the mounting interface 46 on the machine tool side. In the embodiment according to FIG. 7, the mounting projections 44a, 44b, 44c are no longer bead-shaped, but rather mushroom-shaped. Furthermore, three mounting projections 44a, 44b, 44c are now provided overall.

The mounting projections 44a, 44b, 44c are respectively arranged on a circumference of the annular portion 38 of the carrier unit 36.

In addition, the mounting projections 44a, 44b, 44c are now positioned on an upper side of the carrier unit 36, which faces the machine body 14 in a state in which the lighting system 32 is mounted on the hand-operated machine tool 12.

The mounting interface 46 on the machine tool side is also formed on an adapter element 48 for the lighting system shown in FIG. 7. This is shown in detail in FIG. 8.

The adapter element 48 again comprises a ring segment-shaped base body 50, which is provided with openings 52, via which the adapter element 48 can be attached to the machine body 14 by means of screws (not shown in detail).

However, instead of the snap hooks 54a, 54b, the adapter element 48 now has three bayonet fittings 55a, 55b, 55c overall.

The bayonet fittings 55a, 55b, 55c are respectively designed to be coupled to one of the mushroom-shaped mounting projections 44a, 44b, 44c in order to mechanically couple the carrier unit 36 and the adapter element 48.

For this purpose, each of the bayonet fittings 55a, 55b, 55c is designed as an arcuate elongated hole, which runs along the circumference of the ring segment-shaped base body 50.

Each of the elongated holes has a first region with a first diameter and a second region with a second diameter, wherein the first diameter is larger than the second diameter. The first region and second region merge into one another.

The elongated holes are positioned and dimensioned in such a way that one of the mounting projections 44a, 44b, 44c can be inserted into each first region at the same time. The carrier unit 36 and adapter element 48 can be rotated relative to one another starting from this relative position of the carrier unit 36 and adapter element 48 such that each of the mounting projections 44a, 44b, 44c is moved in the direction of a respectively associated second region.

The diameters of the second regions are respectively smaller than the diameters of the heads of the mushroom-shaped mounting projections 44a, 44b, 44c, but larger than the diameters of the stems of the mushroom-shaped mounting projections 44a, 44b, 44c.

As a consequence, the heads of the mushroom-shaped mounting projections 44a, 44b, 44c engage behind the respectively associated second regions as a result of the relative rotation.

The carrier unit 36 and adapter element 48 are therefore mechanically connected to one another in a reliable but releasable manner.

Such connections are also referred to as bayonet connections.

It is understood that the mounting interface 42 of the lighting system 32 described with reference to FIGS. 7 and 8 and the mounting interface 46 on the machine tool side described also merely constitute examples. In particular, a kinematic reversal of the embodiment described is alternatively conceivable in which the bayonet fittings 55a, 55b, 55c are arranged on the carrier unit 36 of the lighting system 32, and mushroom-shaped mounting projections 44a, 44b, 44c are provided on the adapter element 48.

Moreover, it is conceivable to design the mounting interface 46 on the machine tool side as a mounting interface integrated into a housing of the hand-operated machine tool. In this case, no adapter element 48 separate from the hand-operated machine tool 12 is required.

FIG. 9 shows a machine tool assembly 10 in accordance with another embodiment, which again comprises a hand-operated machine tool 12, which is designed as a router, and a lighting system 32. Only the differences with the aforementioned embodiments will be discussed below. In all other respects, the above explanations apply.

In the embodiment in accordance with FIG. 9, the lighting system 32 is integrated into the hand-operated machine tool 12. This means that the lighting unit 56, the control unit 62 and the signal interface 70 are now arranged inside a housing of the hand-operated machine tool 12.

Furthermore, in the embodiment shown in FIG. 9, the signal interface 70 is coupled by means of signals to the drive unit 18, more specifically to a motor control unit 94, which is designed to control the electric motor of the drive unit 18. In this way, the signal interface 70 can receive the signal describing the movement state of the tool 22, which, as before, describes one of the operating frequency, i.e. a rotational speed, and a tool position, i.e. an angular position, of the tool 22.

The electric motor is again designed as a brushless DC motor 96.

Consequently, the signal describing the movement state of the tool 22 can be derived from a drive signal for the DC motor 96. Such a drive signal is, for example, a motor current profile or a motor voltage profile. The motor current profile and the motor voltage profile are present in the motor control unit 94, in particular as input variables for the DC motor 96. Alternatively, an induced voltage and/or an induced current resulting from the rotation of the DC motor 96 and measured by means of the motor control unit 94 can be used. The induced voltage and/or the induced current can thus also be present in the motor control unit 94.

In other words, in the embodiment shown in FIG. 9, the signal describing the movement state of the tool 22 is provided without sensors. Compared to the previous embodiment, the sensor element on the tool side and the sensor element on the carrier unit side can thus in particular be dispensed with.

The machine tool assembly 10 shown in FIG. 9 also has an electrical energy storage unit 64. In contrast to the previous embodiment, however, it is not limited to supplying the lighting unit 56 with electrical energy, but rather is also used to supply the drive unit 18 with electrical energy. The electrical energy storage unit 64 can therefore also be considered the electrical energy storage unit 64 of the hand-operated machine tool 12. In other words, the hand-operated machine tool 12 in the embodiment shown in FIG. 9 is operated by a battery or a rechargeable battery.

With regard to the function of the lighting system 32, reference can be made to the statements regarding the aforementioned embodiments. This also applies in particular to the adjustment means 82 and the display unit 88, which can optionally also be provided in the embodiment in accordance with FIG. 9 and, for example, are arranged on the housing of the hand-operated machine tool 12.

### REFERENCE LIST

10 machine tool assembly
12 hand-operated machine tool
14 machine body
16 grip portion
18 drive unit
20 machine spindle
22 tool
24 machine table
26 linear guide element
28 opening
30 sliding surface
32 lighting system
34 sensor element on the tool side
36 carrier unit
38 annular portion of the carrier unit
40 rectangular portion of the carrier unit
42 mounting interface
44a mounting projection
44b mounting projection
44c mounting projection
46 mounting interface on the machine tool side
48 adapter element
50 base body of the adapter element
52 opening
54a snap hook
54b snap hook
55a bayonet fitting
55b bayonet fitting
55c bayonet fitting
56 lighting unit
58 light source
60 arc line
62 control unit
64 electrical energy storage unit
66 energy interface
68 charging socket
70 signal interface
72 sensor unit
74 sensor element on the carrier unit side
78 mounting interface
80a permanent magnetic element
80b permanent magnetic element
82 adjustment means
84 safety sensor unit
86 electrode
88 display unit
90 display means
92 safety projection
94 motor control unit
96 brushless DC motor
A axis of rotation of the machine spindle, central axis of the opening in the machine table, central axis of the ring segment-shaped portion of the base body of the adapter element, central axis of the annular portion of the carrier unit

1. A machine tool assembly comprising a hand-operated machine tool, which has an electric drive unit with a brushless DC motor and with a motor control unit coupled by signals to the brushless DC motor, and a lighting system, the lighting system comprising:
a lighting unit with at least one light source, wherein the lighting unit is optionally designed in such a way that an engagement portion of a tool of the hand-operated machine tool is configured to be illuminated by the light source in a state of use of the lighting system,
a control unit, which is connected by signals to the lighting unit, wherein the control unit is designed to operate the lighting unit in pulsed light mode,
a signal interface, which is connected by signals to the control unit, wherein the signal interface is designed to receive a signal describing a movement state of the tool such that a lighting state is configured to be adjusted to the movement state by the control unit in pulsed light mode.

2. The machine tool assembly according to claim 1, wherein the signal interface is coupled by signals to the motor control unit for receiving the signal describing the movement state of the tool.

3. The machine tool assembly according to claim 2, wherein the signal describing the movement state of the tool is based on a drive signal for the brushless DC motor provided by the motor control unit and/or wherein the signal describing the movement state of the tool is based on a feedback signal transferred from the brushless DC motor to the motor control unit.

4. The machine tool assembly according to claim 3, wherein the drive signal describes a motor current profile and/or a motor voltage profile and/or
wherein the feedback signal describes an induced voltage profile and/or an induced current profile.

5. The machine tool assembly according to claim 1, wherein the lighting unit, the control unit and the signal interface are arranged inside a housing of the hand-operated machine tool.

6. The machine tool assembly according to one claim 1, wherein the lighting unit, the control unit and the signal interface are attached to a carrier unit and are mechanically attached to an outside of the hand-operated machine tool via a mounting interface provided on the carrier unit.

7. The machine tool assembly according to claim 1, wherein the hand-operated machine tool comprises a machine spindle which is configured to be rotated about an axis of rotation (A), and wherein at least one portion of the lighting system runs parallel to a circumference of the machine spindle at least in sections.

8. The machine tool assembly according to claim 1, wherein the hand-operated machine tool is a router.

9. A lighting system for a machine tool assembly according to claim 1, the lighting system comprising:
the lighting unit with at least one light source, wherein the lighting unit is optionally designed in such a way that an engagement portion of a tool of the hand-operated machine tool is configured to can be illuminated by the light source in a state of use of the lighting system,
the control unit, which is connected by signals to the lighting unit, wherein the control unit is designed to operate the lighting unit in pulsed light mode,
the signal interface, which is connected by signals to the control unit, wherein the signal interface is designed to receive a signal describing a movement state of the tool such that a lighting state is configured to be adjusted to the movement state by the control unit in pulsed light mode.

10. The lighting system (32) according to claim 9, wherein the signal interface is designed to be coupled by signals to a motor control unit for receiving the signal describing the movement state of the tool, wherein the motor control unit is designed to control a brushless DC motor.

11. The lighting system according to claim 9, comprising:
an energy interface for supplying the lighting unit and/or the control unit with electrical energy.

12. The lighting system according to claim 11, comprising:
an electrical energy storage unit, which is coupled to the energy interface.

13. (canceled)

14. The lighting system according to claim 9, further comprising:
a carrier unit with a mounting interface for the optional mechanical attachment of the carrier unit to an outside of the hand-operated machine tool, wherein the lighting unit and control unit are attached to the carrier unit.

15. The lighting system according to claim 14, wherein the carrier unit has at least one annular or ring segment-shaped portion.

16. The lighting system according to claim 9, wherein the lighting unit comprises a plurality of light sources and the light sources are arranged along an arc line.

17. The lighting system according to claim 9, wherein the signal interface is designed to receive, as the signal describing the movement state of the tool, at least one of a signal describing an operating frequency of the tool and a signal describing a tool position of the tool.

18. The lighting system according to claim 17, comprising a sensor unit, wherein the sensor unit is designed to detect the operating frequency and/or the tool position and to produce the signal describing the operating frequency and/or tool position and is coupled by signals to the signal interface.

19. The lighting system according to claim 14, wherein the sensor unit comprises a sensor element on the carrier unit side, which is attached to the carrier unit.

20. The lighting system according to claim 18, wherein the sensor unit comprises a sensor element on the tool side, which is configured to be coupled to the tool or to a drive element coupled to the tool or which is configured to be integrated into the tool or the drive element.

21. The lighting system according to claim 20, wherein the sensor element on the tool side is annular and has a mounting interface on an inner ring circumference for coupling to the tool or the drive element.

22. The lighting system according to claim 9, wherein at least one of a lighting frequency and lighting phase position is configured to be adjusted to the movement state of the tool as the lighting state by the control unit in pulsed light mode.

23. The lighting system according to claim 22, comprising:
an adjuster for manually modifying at least one of the lighting frequency and lighting phase in pulsed light mode, wherein the adjuster is connected by signals to the control unit.

24. The lighting system according to one of claim 9, comprising:
a display unit for displaying at least one of an operating state of the lighting system, warning message, error message and user feedback.

25. The lighting system according to claim 24, wherein the display unit comprises at least one display separate from the lighting unit.

26. The lighting system according to one of claim 9, comprising:
a safety sensor unit, which is attached to the carrier unit, wherein the safety sensor unit is designed to detect a human finger or human hand in the region of the carrier unit, and wherein the safety sensor unit is coupled by signals to the control unit such that an operating state of the lighting unit is configured to can be adjusted as a function of a detection result of the safety sensor unit.

27. A machine tool assembly according to claim 1, wherein the brushless DC motor is without sensors.

28. The lighting system according to claim 9, wherein the signal interface is designed to be coupled by signals to a motor control unit for receiving the signal describing the movement state of the tool, wherein the motor control unit is designed to control a brushless DC motor, wherein the DC motor is without sensors.
